(19) United States
(12) Patent Application Publication
(10) Pub. No.: US 2010/0032271 A1
(43) Pub. Date: Feb. 11, 2010

(54) SWITCH

(75) Inventor: Masataka Maehara, Tokyo (JP)

Correspondence Address: DARBY & DARBY P.C., P.O. BOX 770, Church Street Station, New York, NY, 10008-0770, US

(73) Assignee: SMK Corporation, Tokyo (JP)

(21) Appl. No.: 12/360,184

(22) Filed: Jan. 27, 2009

(30) Foreign Application Priority Data
Aug. 7, 2008 (JP) 2008-204393

(51) Int. Cl. H01H 21/04

(52) U.S. Cl. 200/294

(57) ABSTRACT

A switch having terminals that provide from side surfaces of a switch housing for mounting on a substrate. Through-holes are provided in the terminals. A main body is installed in a cutaway part of the substrate to form a gap between the housing side surface and the cutaway part. When soldering a solder connection surface of the terminal to the solder mounting surface of the substrate, flux flows out to a substrate end surface through a space formed continuously between each through-hole and the gap, such that there is no penetration of flux into the interior of the switch. As a result, contact operation is made stable. In addition, the solder connection strength is also improved by forming a solder fillet on the interior surface of the through-hole.

### CROSS-REFERENCE TO RELATED APPLICATIONS

This application claims priority from Japanese Patent Application No. 2008-204393, filed Aug. 7, 2008, which is incorporated by reference herein in its entirety.

### FIELD OF THE INVENTION

The present invention relates to a switch (for example, a push button switch) mounted on a substrate (for example, a printed circuit substrate) of various types of electronic devices; and more particularly relates to a push button switch mounted in the cutaway part of a substrate.

### BACKGROUND OF THE INVENTION

As indicated in FIGS. 11 and 12 and described by Japanese Unexamined Patent Application No. 2006-210195, which is incorporated by reference herein in its entirety, in the past a type of push button switch 100 comprised a housing 110, which housed a contact point and was installed on a substrate 170, and a push button 120, which protruded from one side surface 111 of housing 110 and could be manipulated in the direction parallel to the board surface of the substrate 170. The housing 110 had terminals 130 that connected to the contact point and led out from the side surfaces 111; the terminals 130 had solder surfaces 131 for soldering to the substrate 170; and the terminals 130 lead out from the side surfaces 111 of the housing 110 in front and back pairs in the direction of manipulation of the push button 120.

Nonetheless, in the previously described conventional example, no opening such as a through-hole or a cutaway was formed in the terminals 130, and therefore it was difficult to make a large solder contact surface area for the solder connection of the push button switch to the substrate 170, and great solder adhesion strength could not be obtained. Moreover, because no openings were formed in the terminals 130, while soldering the push button switch 100 to the substrate 170, flux was prone to travel along the terminal 130 when melting the solder and to penetrate into the push button switch 100 from between the housing 110 and a metal cover 160 secured outside of the housing 110 based on capillary action.

Then, as electronic devices have become more compact, when mounting the push button switch on the substrate, a cutaway part was formed in the substrate in order to control the height of the substrate, and this created problems regarding the method of installing and mounting the push button switch into this cutaway part.

### SUMMARY OF THE INVENTION

In light of the problems described above, in forming a cutaway part in a substrate in order to control the height above the substrate surface when mounting a switch into this cutaway part, an object of the present invention is to be able to increase the strength of the solder connection to the substrate and to offer a switch for mounting on substrate wherein the penetration of flux into the interior of the switch can be controlled.

In a first embodiment of the present invention, a switch has a main body which is installed into and mounted on a cutaway part formed in a substrate. Terminals of the switch include through-hole parts plated on inner surfaces protrude from side surfaces of the aforementioned main body. When mounting the aforementioned terminals on the aforementioned substrate, a gap is formed between the side surfaces of the aforementioned main body and the aforementioned cutaway part, and part of the aforementioned through-hole has a space continuous with the aforementioned gap.

The invention as realized in the first embodiment comprises a switch the main body of which is installed into and mounted on a cutaway part formed in a substrate in order to reduce the mounting height. Because one part of a through-hole formed in the terminals has a space connected with a gap provided between the switch main body and the substrate, when mounting the switch on the substrate by soldering, flux traveling along the terminal and penetrating into the interior of the main body can be prevented because the flux stopped in the through-hole part of the terminal flows out to the terminal surface of the substrate. Moreover, because the terminals are plated on the inner surfaces of the through-holes, solder fillets are formed along the entire inner surfaces, and the mounting strength can be increased.

Preferably, the aforementioned main body comprises a housing consisting of an insulative body having an opening, a manipulation member housed within the aforementioned opening so as to be moveable, an operable contact piece arranged inside the opening and operated by the aforementioned manipulation member, and a cover that covers the aforementioned opening. Multiple fixed contact points, with which the aforementioned movable contact piece connects and disconnects, are also provided, spaced with gaps on the bottom surface of the aforementioned opening; and the aforementioned fixed contact points are connected with the aforementioned terminals.

This configuration enables stable mounting strength and stable operation when mounting a switch to which operational force is applied in order to operate the moveable contact piece.

Preferably, the aforementioned housing or the aforementioned cover forms protrusions that protrude in nearly the same direction as the aforementioned terminals.

Because a protruding part that protrudes in the same direction as the terminal is formed in the housing or cover that configures the switch, when mounting the switch on the substrate, fixed gaps can be provided between the main body of the switch and the substrate without using special methods such as jigs or image recognition, thereby enabling stable mounting strength and stable operation.

Preferably, the aforementioned housing or the aforementioned cover forms multiple protrusions that protrude having nearly an equivalent amount of protrusion in nearly the same direction as the aforementioned terminals, and when the aforementioned main body is installed into the aforementioned cutaway part, the aforementioned gaps are aligned nearly equally by the aforementioned protrusions.

By forming on the housing or cover that configures the switch protruding parts having equal amounts of protrusion, stable mounting strength and stable operation are made possible by the flux reliably flowing out at the substrate terminal surface when mounting. In addition, the switch can be easily centered by regulating the gaps to equal amounts.

### BRIEF DESCRIPTION OF THE DRAWINGS

The present invention will become more readily apparent from the Detailed Description of the Invention, which proceeds with reference to the drawings, in which:

FIG. 1 presents a top plan view of a push button switch according to the present invention;

FIG. 2 presents a cross-sectional view of the push button switch along section 2-2 of FIG. 1;

FIG. 3 presents a top perspective view of the push button switch of FIG. 1;

FIG. 4 presents a bottom perspective view of the push button switch of FIG. 1;

FIG. 5 presents a bottom perspective view of the push button switch of FIG. 1, as mounted on a substrate;

FIG. 6 presents a front view of the push button switch illustrated in FIG. 5 along a direction of operation labeled by the arrow “Y” in FIG. 5;

FIG. 7 presents a bottom view of the push button switch in FIG. 5 along a direction labeled by the arrow “Z” in FIG. 5;

FIG. 8 presents a bottom perspective view of another embodiment of the push button switch in which latch parts of the cover of the push button switch in FIG. 5 are extended;

FIG. 9 presents a bottom perspective view of yet another embodiment of the push button switch having extended cover latch parts;

FIG. 10 presents a cross-sectional view of the push button switch of FIG. 5 along the section 10-10 of FIG. 5, illustrating the soldering of terminals to the substrate;

FIG. 11 provides a top perspective view of a conventional push button switch; and

FIG. 12 provides a bottom perspective view of the conventional push button switch of FIG. 11.

### DETAILED DESCRIPTION OF THE INVENTION

A listing of some of the reference numerals that are used in the drawings, together with descriptions of the corresponding elements, is provided below.

| | | | |
|---|---|---|---|
| 10 | Push button switch | 11 | Main body |
| 20 | Housing | 21 | Housing side surface |
| 22 | Opening | 23 | Bottom surface part |
| 24 | Latch convex part | 25 | Housing bottom surface |
| 26 | Convex part | 30 | Terminal |
| 31 | Solder connection part of | 32 | Through-hole |
| | terminal | | |
| 33 | Cutaway part | 34 | Contact point |
| 35 | Solder connection surface | 36 | Inner surface |
| 37 | End surface | 40 | Contact plate |
| 50 | Substrate | 51 | Solder mounting surface of |
| | | | substrate (mounting pattern) |
| 52 | Substrate cutaway part | 53 | Substrate cutaway end surface |
| 60 | Manipulation member | 61 | Tip part |
| 62 | Push part | 63 | Push piece |
| 64 | Perpendicular flat surface | 65 | Manipulation part |
| 70 | Cover | 71 | Top surface part |
| 72 | Guide tongue part | 73 | Latch part |
| 74 | Bent part | 80 | Solder fillet |
| 90 | Gap | 91 | Connected space |
| 100 | Conventional push button | 101 | Connection point |
| | switch | | |
| 110 | Housing | 111 | Housing side surface |
| 112 | Housing bottom surface | 120 | Push button |
| 130 | Terminal | 131 | Surface with solder |
| 132 | Solder connection part | 133 | Output part |
| 160 | Metal cover | 170 | Substrate |

Next, several embodiments of the present invention will be explained. These embodiments are provided to illustrated principles of the present invention, and are non-limiting.

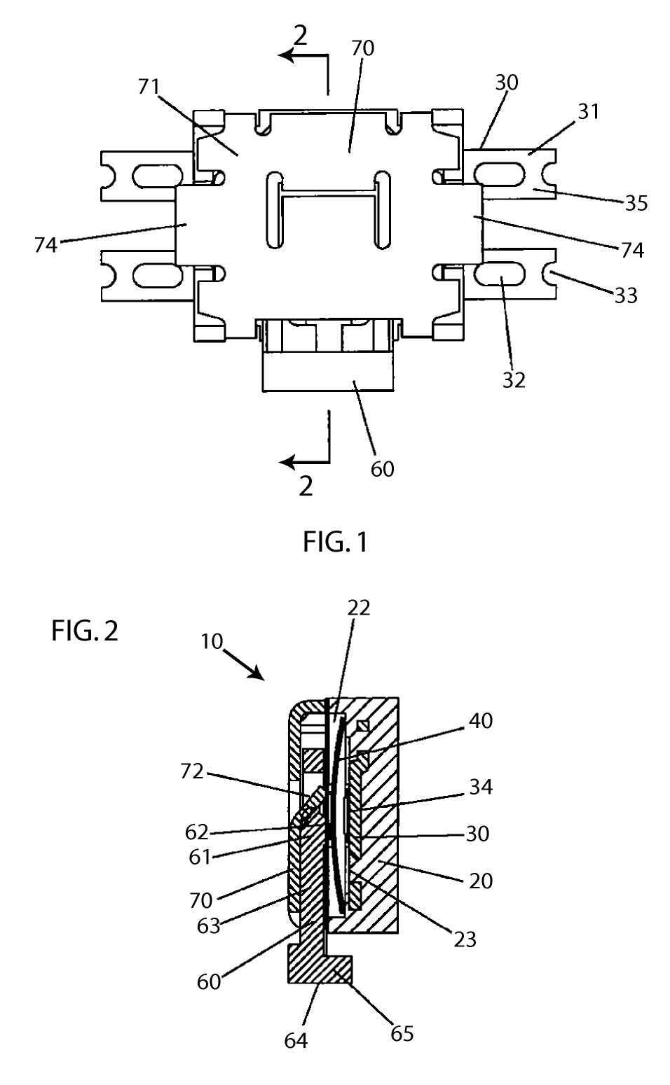

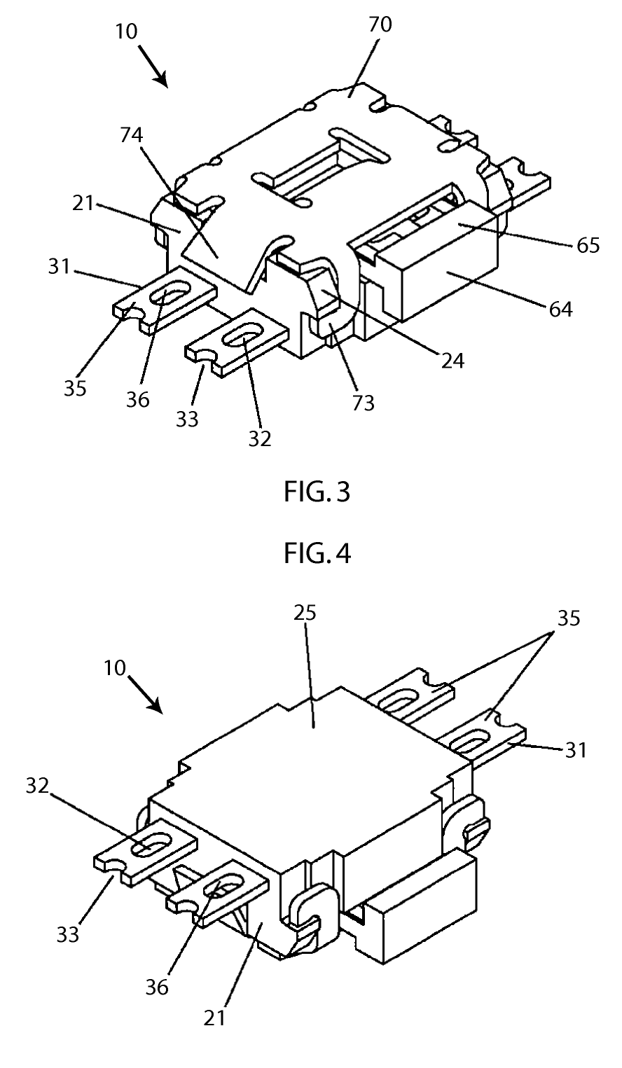

FIGS. 1-4 illustrate a push button switch 10 according to the present invention, which has a structure that incorporates a conductive contact plate 40 and a manipulation member 60 into a housing 20 containing contact points 34, and that covers these parts with a cover 70 installed from above. The individual parts are described further below.

The housing 20 comprises of an insulative material, and has an opening 22 on the upper side. Terminals 30, with contact points 34 in between and exposed on the opening side, are formed into a single body with the housing 20 on the bottom surface part 23, which is provided on an inner surface of the housing.

A contact plate 40 preferably comprises a conductive thin metal plate having a convexly curved dish shape with a thickness of about 0.01 to 0.05 mm, is separated from one contact point 34 with the central part exposed from the housing 20, and is installed in the housing 20 positioned at another contact point 34 at the peripheral part of the housing 20.

A manipulation member 60 includes a push piece 63, in which a hemispherical push part 62 is provided on a tip part 61, and a manipulation part 65, which has a flat surface 64 perpendicular to the direction of manipulation positioned on the exterior of the housing during installation. The manipulation member is installed in the housing such that a line connecting the push part 62 and the center of the contact plate 40, which is installed in the push button switch 10, matches the direction of manipulation.

Then, once this manipulation member 60 has been installed, the approximate center of an upper surface part 71, which is made of thin plate metal, is cut and then a guide tongue part 72 that protrudes at a downward slant is formed. When combined with housing 20, the opening part 22 of the housing is closed off and assembly of the push button switch 10 is completed by forming bent parts 74, which are bent having an equal amount of left and right protrusion in the same direction as the terminals 30 that protrude from housing 20, and by latching the cover 70, which has multiple latch parts 73 that are bent downward extended out from the tip parts of the upper surface part 71 that has roughly the same form as the outer shape of the housing, onto latch nubs 24 formed in the housing 20.

With the push button switch 10 assembled in this way, as illustrated in FIG. 2, by applying force roughly perpendicular to the aforementioned flat surface 64 of the manipulation part 65, the push part 61 of the manipulation member 60 moves downward based on the guide tongue part 72 formed in the cover 70, the two contact points 34 make electrical continuity through the contact plate 40 by the central convex part of the contact plate 40 contacting the one contact point exposed by the housing 20, and the switch is turned ON.

Next, with reference in addition to FIG. 5, the structure of the terminals 30, which are soldered when mounting the present push button switch 10 onto the substrate 50, will be explained. The terminals 30 are made of conductive thin plate metal; as previously described, one end is formed in a single body inside the housing where the contact point 34, which is exposed to the opening part side of the housing 20, is formed; and a solder connection part 31, which is soldered to the substrate on which the push button switch 10 is mounted, is formed on the other end. These solder connection parts 31 have a long plate shape; slotted through-holes 32 preferably having semicircles on both sides are formed in the direction of plate thickness. Semicircular cutaway parts are preferably provided in the longitudinal ends of the solder connection parts 31. Solder connection is reliably made to the inside surface 36 in the plate thickness direction of the through-hole 32 and the semicircular cutaway part; using any of a variety of types of plating such as Ag plating is executed in order to form solder fillets between the inner surface 36 and a mounting pattern 51 formed in the substrate.

In addition to making compact and thin electronic devices of various kinds, the push button switch 10 facilitates a mounting method that installs and mounts the main body 11 of the push button switch 10 onto a substrate 50, on which a circuit is formed and which has a roughly rectangular shaped substrate cutaway part 52 as indicated in FIG. 5, and the mounting height when mounting the push button switch 10 on the substrate 50 can thereby be reduced.

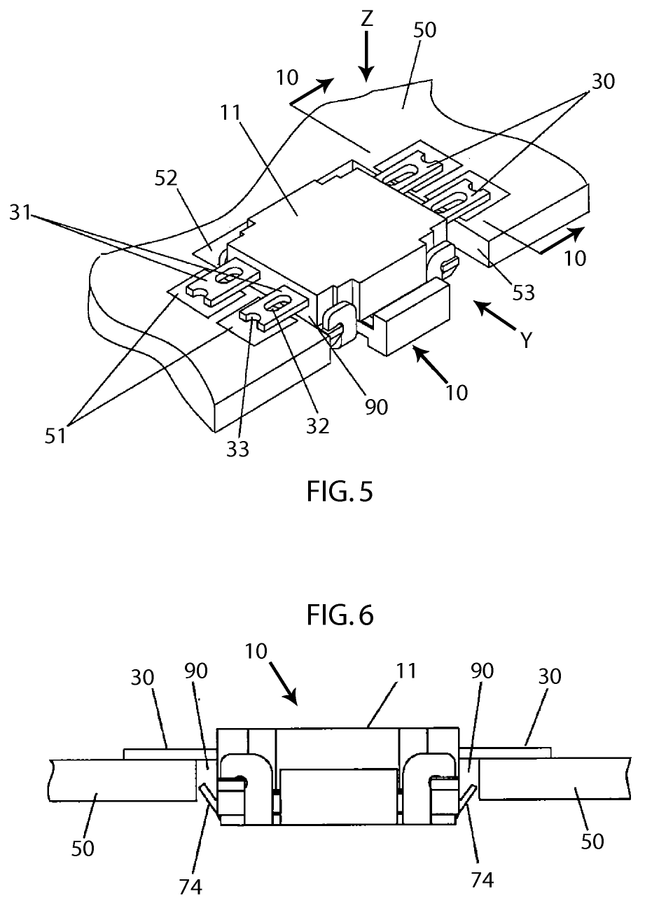

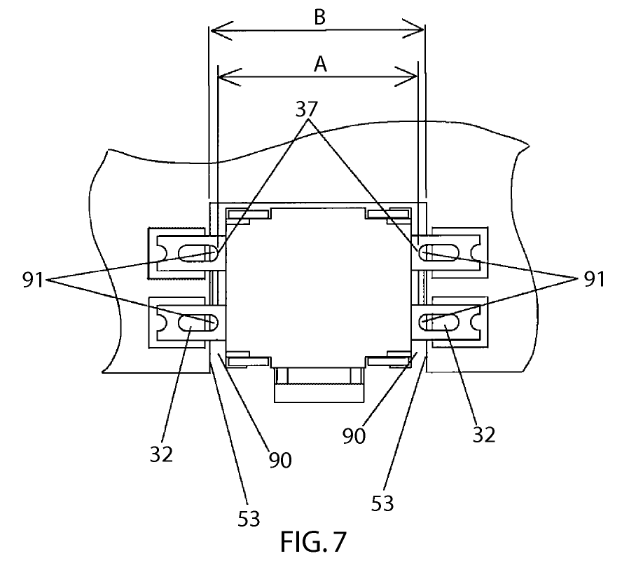

The cutaway area of the substrate cutaway part 52 is larger than the main body 11 in the direction that the terminals 30 of the push button switch 10 protrude. When the main body 11 is installed in the substrate cutaway part 52, as illustrated in FIGS. 6 and 7, gaps 90 are formed between the main body 11 and the substrate cutaway part 52 in the direction that the terminals 30 of the push button switch 10 protrude. When mounting the switch 10, the gaps in the left and right directions of the main body 11 may be made equal, for example, by means of a technology such as image recognition. The left and right gaps 90 are kept nearly equal because the bent parts 74, which have a nearly equal amount of protrusion in the direction that the terminals 30 protrude from the housing side surfaces 21, are formed on the cover 70 of the main body 11.

The majority of the area of the opening of the through-hole 32 thereby formed in the terminal 30 is positioned above the substrate 50, but part of the area of the through-hole 32 is positioned not above the substrate 50 but above the gap 90 because the distance A between terminal surfaces 37 nearest to the main body 11 of the through-holes 32 of the left and right terminal parts formed in the direction of terminal protrusion as illustrated as in FIG. 7 is smaller than the length B of the cutaway part 52 in the direction of terminal protrusion. This part of the through-hole is positioned to have a space that connects with the gap 90.

To mount and solder the push button switch 10 to the substrate 50, paste solder is printed or coated on the mounting patterns 51 formed on the substrate in a shape roughly similar to the solder connection parts 31. Mounting equipment or the like then places the push button switch 10 on the substrate so that the solder connection parts 31 of the push button switch 10 are mated with the mounting patterns 51. Next; the solder is fused, for example, by passing the push button switch 10 mounted on this substrate 50 through a reflow tank at approximately 300° C. The mounting patterns 51 of the substrate and the solder connection parts 31 are soldered together, and the push button switch 10 and the substrate 50 become electrically connected.

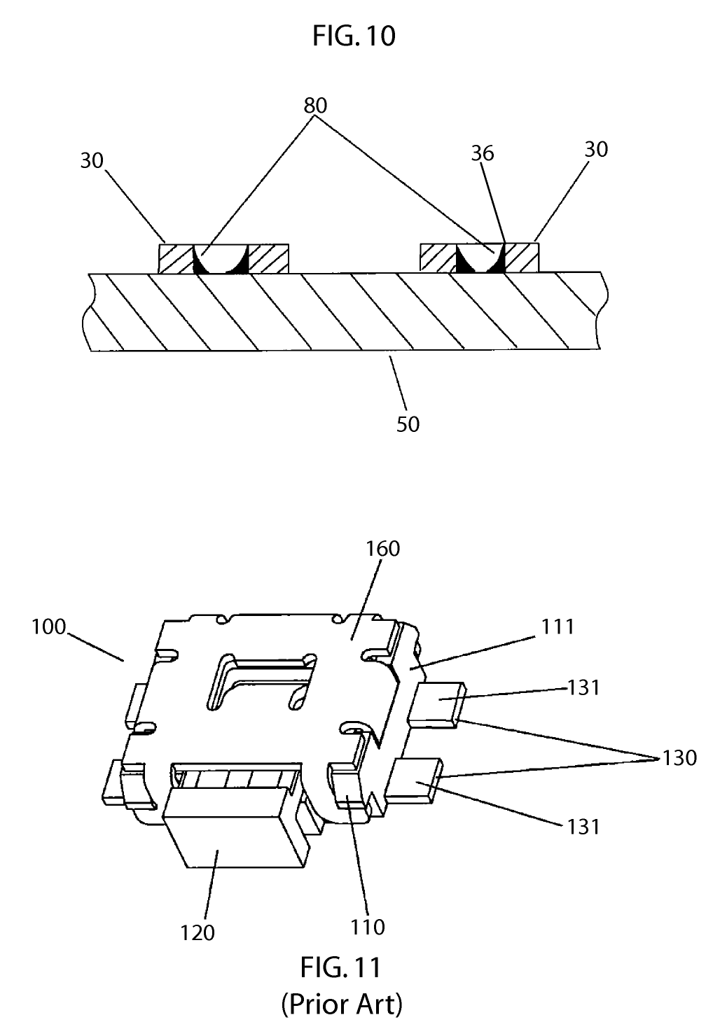

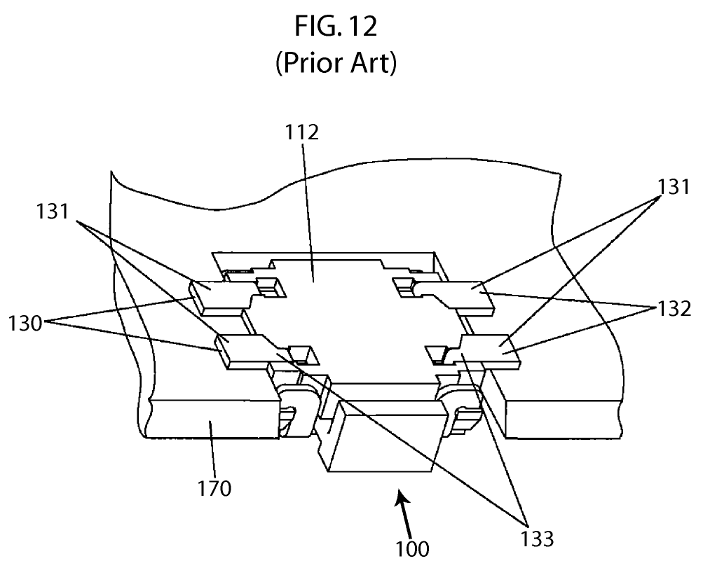

At this time, the solder is fused and a solder fillet is formed at the corner parts formed by the plate thickness direction wall surfaces of the solder connection part 31 and the mounting pattern 51 of the substrate. Consequently, with the solder connection part 31 of the present push button switch 10, not only is a solder fillet formed on the long plate shaped outer periphery, but a solder fillet 80 is also formed on the wall surface, which is the inner surface 36 of the slotted through-hole 32 opened in the previously described solder connection part 31 (see, e.g., FIG. 10). Compared to conventional solder connection parts that do not form the through-hole 32, the present push button switch 10 thereby increases the solder connection force with the substrate 50 by the portion of solder fillet formed by the through-hole 32, making it possible to increase the strength of the push button switch 10 to resist peeling from the mounting pattern 51 compared to the conventional push button switch 100. Further, here in conventional situations flux flows into the inner surface 36 of the through-hole 32 at the same time as the fillet is formed on the through-hole 32 because plating processing was conducted, the flux simply pools in the hole formed by the through-hole 32 and the substrate, and if there is a large amount, the flux overflows from the hole part formed by the through hole 32 and the substrate, travels along the terminal 30, and penetrates into the main body 11. Nonetheless, as illustrated in FIG. 7, because the present invention has a space 91 in which part of the through-hole 32 is continuous with the gap 90, the flux temporarily pooled in the hole formed by the through-hole 32 and the substrate flows out into the cutaway end surface 53 of the substrate 50 through the space 91 continuous with the gap 90, and therefore the amount of flux that travels along the terminal 30 and flows into the main body is vastly reduced, and the penetration of flux into the push button switch can be advantageously suppressed.

In this way, the present switch provides gaps 90 between the mounting substrate that are regulated by the bent parts 74 that protrude from the cover, and by forming in the switch terminal part a through-hole 32 that has a space 91 connecting between part of the through-hole and the gap, the flux produced by soldering during mounting passes through the space 91 formed between the through-hole 32 and the gap 90 and flows out along the end surface 53 of the substrate cutaway part 52, thus providing a countermeasure to flux traveling along the terminal part 30 and penetrating into the interior of the switch main body 11. Unsatisfactory fusion of the switch and other undesirable effects may thus be prevented, stable operation becomes possible, and the mounting strength is improved by solder fillets formed on the inner surface 36 of the through whole 32.

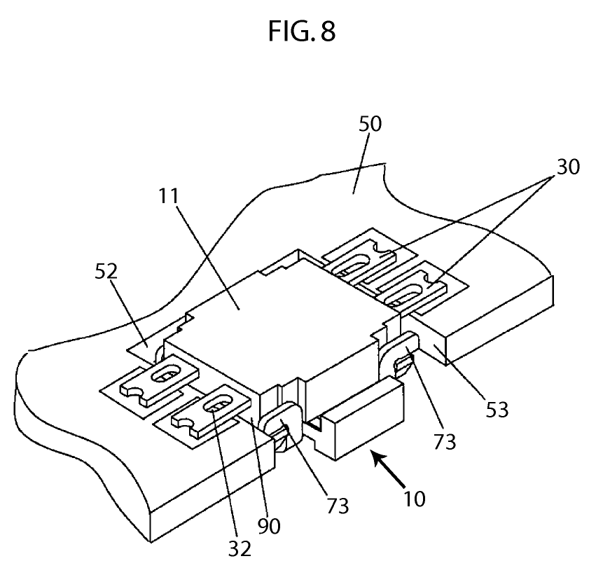

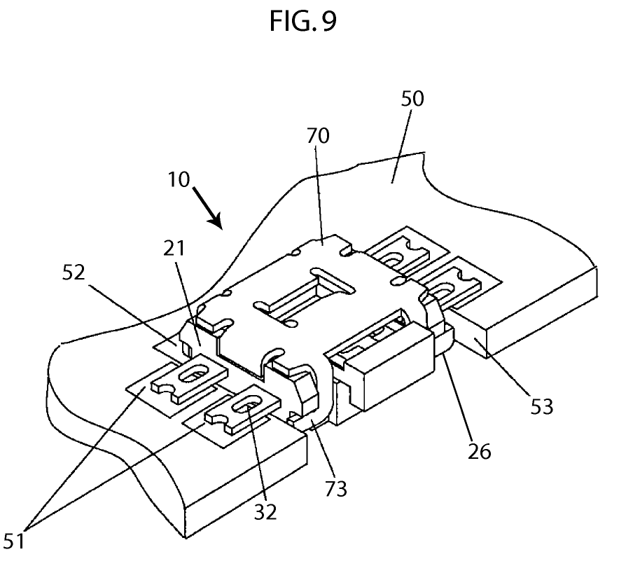

In the present embodiment, the bent parts 74 are formed on the cover 70 in order to regulate the gap 90, but implementation of the present invention is not limited to this configuration. As indicated in FIGS. 8 and 9, for example, the present invention may also be implemented by regulating the gap 90 by extending the latch parts 73 of the cover 70 out in the direction of protrusion of the terminals 30; or by forming convex parts 26 from the housing 20 of the main body 11 in the direction of protrusion of the terminals 30. Further, in addition to the through-holes 32 formed in the terminals 30 having a semicircular shape at both ends, the present invention may be implemented, for example, with rectangular through-holes. As long as there is a space connecting part of the through-hole with the gap 90, the shape does not matter. Also, the present invention may also be implemented in a form in which the cutaway is provided in the direction of protrusion of the terminals.

One skilled on the art will readily recognize additional adaptations and modifications which can be made to the present inventions which fall within the scope of the invention as defined by the claims. Moreover, it is intended that the scope of the present invention include all foreseeable equivalents to the structure as described with reference to FIGS. 1-10. Accordingly, the invention is to be limited only by the scope of the claims and their equivalents.

I claim:

1. A switch comprising:
a main body configured to be mounted in a cutaway part formed in a substrate; and
terminals having through-hole parts plated on inner surfaces and protruding from side surfaces of said main body; wherein
when said switch is mounted and said terminals are installed on said substrate, gaps are formed between the side surfaces of said main body and said cutaway part, and part of an area of each said through-hole parts has space continuous with one of said gaps.

2. The switch according to claim 1, wherein said main body comprises:
a housing including an insulative body having an opening;
a manipulation member moveably housed within said opening;
an operable contact piece arranged inside the opening and operated by said manipulation member;
a cover that covers said opening; and
multiple fixed contact points, with which said movable contact piece connects and disconnects, said multiple fixed contact points being spaced with gaps on a bottom surface of said opening, and being connected with said terminals.

3. The switch according to claim 2, wherein;
one of said housing or said cover forms protrusions that protrude in nearly the same direction as said terminals, and
when said main body is installed into said cutaway part, said gaps between the side surfaces of said main body and said cutaway part are aligned nearly equally by said protrusions.

4. The switch according to claim 2, wherein;
one of said housing or said cover forms multiple protrusions that protrude having nearly an equivalent amount of protrusion in nearly the same direction as said terminals, and
when said main body is installed into said cutaway part, said gaps between the side surfaces of said main body and said cutaway part are aligned nearly equally by said protrusions.

5. A method for providing a switch in a cutaway part formed in a substrate, wherein said switch comprises a main body and terminals having through-hole parts plated on inner surfaces of the through-hole parts and which protrude from side surfaces of said main body, said method comprising the step of:
installing said main body in said cutaway part, so that gaps are formed between the side surfaces of said main body and inner edges of the cutaway part,
wherein a part of an area of each of said through-holes has a space that is continuous communication with one of said gaps.

6. The method of claim 5, further comprising the step of:
forming multiple protrusions in one of a cover or a housing of said main body which are configured so that, when said main body is installed in said cutaway part, said gaps are nearly aligned by said protrusions.
